(19) United States
(12) Patent Application Publication
(10) Pub. No.: US 2026/0203846 A1
(43) Pub. Date: Jul. 16, 2026

(54) Detection, Data Management, and Report Distribution of Treatment Status of a Subject in a Facility

(71) Applicant: Softbank Group Corp., Tokyo (JP)

(72) Inventors: Takafumi Ogane, Tokyo (JP); Taku Hiraoka, Tokyo (JP); Satura Horiguchi, Tokyo (JP); Taiki Hayashi, Tokyo (JP); Naoaki Satake, Tokyo (JP)

(21) Appl. No.: 19/447,506

(22) Filed: Jan. 13, 2026

(30) Foreign Application Priority Data
Jan. 16, 2025 (JP) 2025-006395

(51) Int. Cl. G06Q 50/22; G06V 20/52

(52) U.S. Cl. CPC G06Q 50/22; G06V 20/52

(57) ABSTRACT

A data processing device may include: an input unit that acquires user data; a processing unit that performs specific processing using a data generation model that generates a predetermined inference result according to the user data; and an output unit that outputs a result of the specific processing to a predetermined device. The input unit may acquire, as the user data, image data indicating an image of a subject in a facility, such as a childcare recipient in a childcare facility. The processing unit may perform, as the specific processing, generating report information for reporting the subject’s childcare status in the facility based on the user data by inputting, into the data generation model, a prompt for instructing the data generation model to generate the report information. The output unit may output information based on the generated report information to a predetermined report destination device.

### CROSS REFERENCE TO RELATED APPLICATIONS

The present application claims priority from Japanese Patent Application No. 2025-006395, filed on January 16, 2025, the entire disclosure of which is incorporated herein by reference.

### BACKGROUND

### Technical Field

The technology of the present disclosure relates to a data processing device, a data processing method, and a data processing program.

### Related Art

Japanese Patent Application Laid-Open (JP-A) No. 2022-180282 discloses a persona chatbot control method executed by at least one processor. The method includes: receiving a user utterance; adding the user utterance to a prompt that includes an instruction statement associated with a description of a chatbot character; encoding the prompt; and inputting the encoded prompt into a language model to generate a chatbot utterance responding to the user utterance.

### SUMMARY OF THE INVENTION

### Technical Problem

The prior art does not address reducing the burden on childcare providers in a childcare facility, and there is room for improvement in this regard.

### Solution to the Problem

A first aspect of the present disclosure relate to a data processing device that may include: an input unit configured to acquire user data; a processing unit configured to perform, using a data generation model, specific processing that generates a predetermined inference result (e.g., an inference result including predetermined types of information) according to the user data; and an output unit configured to output the predetermined inference result of the specific processing to a predetermined device. The input unit may acquire, as the user data, image data indicating an image of a childcare recipient in a childcare facility. The processing unit may perform, as the specific processing, generating, based on the users data, report information that indicates childcare status of the childcare recipient in the childcare facility by inputting, into the data generation model, a prompt for instructing the data generation model to generate the report information. The output unit may output information, based on the generated report information, to a predetermined report destination device.

A second aspect of the present disclosure is a data processing method executed by a computer, the data processing method including: acquiring user data; performing specific processing using a data generation model that generates a predetermined inference result according to the user data; and outputting a result of the specific processing to a predetermined device, in which image data indicating an image of a childcare recipient in a childcare facility is acquired as the user data, processing of generating report information for reporting childcare status of the childcare recipient in the childcare facility based on the user data by inputting, into the data generation model, a prompt for instructing the data generation model to generate the report information is performed as the specific processing, and information based on the generated report information is output to a predetermined report destination device.

A third aspect according to the technology of the present disclosure is a data processing program for causing a computer to execute: acquiring user data; performing specific processing using a data generation model that generates a predetermined inference result according to the user data; and outputting a result of the specific processing to a predetermined device, in which image data indicating an image of a childcare recipient in a childcare facility is acquired as the user data, processing of generating report information for reporting childcare status of the childcare recipient in the childcare facility based on the user data by inputting, into the data generation model, a prompt for instructing the data generation model to generate the report information is performed as the specific processing, and information based on the generated report information is output to a predetermined report destination device.

### BRIEF DESCRIPTION OF THE DRAWINGS

FIG. 1 is a diagram illustrating an example of a data processing system;

FIG. 2 is a diagram illustrating example functions of a data processing device and a smart device;

FIG. 3 is a diagram illustrating processing according to an example;

FIG. 4 is a block diagram illustrating an example processing unit of a data processing device;

FIG. 5 is a flowchart illustrating an example of a first specific processing operation performed by a data processing device;

FIG. 6 is a diagram illustrating an example of a daily record check screen;

FIG. 7 is a flowchart illustrating an example of a second specific processing operation performed by a data processing device;

FIG. 8 is a flowchart schematically illustrating an example of a flow of a third specific processing operation performed by the data processing device according to an example; and

FIG. 9 is a diagram illustrating an example of an event report screen according to an example.

### DETAILED DESCRIPTION OF THE INVENTION

Hereinafter, examples of a data processing device, a data processing method, and a data processing program according to the technology of the present disclosure will be described with reference to the accompanying drawings.

First, words used in the following description will be described.

In the following examples, a processor to which a reference sign is attached (hereinafter, simply referred to as “processor”) may comprise one arithmetic device or a combination of a plurality of arithmetic devices. Additionally and/or alternatively, the processor may comprise one type of arithmetic device or a combination of a plurality of types of arithmetic devices. Examples of the arithmetic device include a central processing unit (CPU), a graphics processing unit (GPU), a general-purpose computing on graphics processing unit (GPGPU), an accelerated processing unit (APU), and the like.

In the following examples, a random-access memory (RAM) to which a reference sign is attached may comprise a memory in which information is temporarily stored. Such memory may be used as a work memory by the processor.

In the following examples, a storage to which a reference sign is attached may comprise one or more nonvolatile storage devices that store various programs, various parameters, and/or the like. Examples of the nonvolatile storage device include a flash memory (solid state drive (SSD)), a magnetic disk (e.g., a hard disk), and a magnetic tape.

In the following examples, a communication interface (I/F) to which a reference sign is attached may comprise an interface including one or more of: a communication processor, an antenna, etc. The communication I/F may manage communication between a plurality of computers. Examples of the communication standard applied to the communication I/F may include wireless communication standards, including a 5th generation mobile communication system (5G), Wi-Fi (a registered trademark of the Wi-Fi Alliance of Austin, Tx), and Bluetooth (a registered trademark of Bluetooth SIG, Inc. of Kirland, WA).

In the following examples, “A and/or B” is synonymous with “at least one of A or B.” That is, “A and/or B” means only A, only B, or a combination of A and B. Furthermore, in the present specification, the same concept as “A and/or B” is applied also in a case where three or more things are expressed in a combined manner by “and/or”.

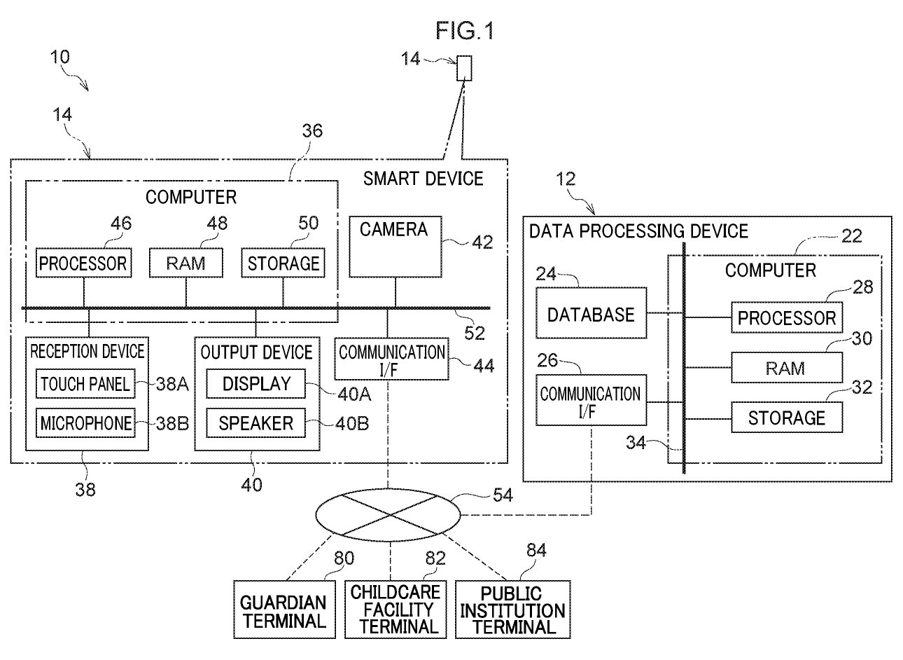

FIG. 1 illustrates an example of a configuration of a data processing system 10. Hereinafter, a case where a nursery school or childcare facility may be applied as a facility of the present disclosure, a nursery school teacher, teacher, or childcare provider may be applied as a first person of the present disclosure, and a child, children, or childcare recipient may be applied as a subject (of the present disclosure will be described.. However, the facility, the first person, and the subject are not limited to this mode, and for example, a facility for after-school care may be applied as the facility of the present disclosure, an after-school care teacher may be applied as the first person of the present disclosure, and an adolescent or impaired adult may be applied as the subject of the present disclosure. For simplicity, use of specific examples such as “nursery school” and “after-school facility” is understood to provide support for these specific examples, as well as more generally, a “facility” in the claims. Similarly, examples such as “childcare provider” or “teacher” are understood to provide support for these specific examples, as well as more generally, a “person” in the claims. Examples such as “child,” children,” and “childcare recipient” are also understood to provide support for these specific examples, as well as more generally, a “subject” in the claims.

As illustrated in FIG. 1, the data processing system 10 is depicted by way of example as including a data processing device 12 and a smart device 14. Examples of the data processing device 12 include a server. Examples of the smart device 14 include a smartphone. In the present example, the data processing device 12 is an example of a “data processing device” according to the technology of the present disclosure. The smart device 14 according to the present example may be associated with or owned by a facility targeted by the data processing system 10 (hereinafter, simply referred to as “nursery school”).

The data processing device 12 may include a computer 22, a database 24, and a communication interface (I/F) 26. The computer 22 is an example of a “computer” according to the technology of the present disclosure. The computer 22 may include a processor 28, a RAM 30, and/or a storage 32. The processor 28, the RAM 30, and/or the storage 32 may be connected to a bus 34. The database 24 and/or the communication I/F 26 may also be connected to the bus 34. The communication I/F 26 may further be connected to a network 54. Examples of the network 54 include a wide area network (WAN) and/or a local area network (LAN).

The smart device 14 may include a computer 36, a reception device 38, an output device 40, a camera 42, and/or a communication I/F 44. The computer 36 may include a processor 46, a RAM 48, and/or a storage 50. The processor 46, the RAM 48, and/or the storage 50 may be connected to a bus 52. The reception device 38, the output device 40, and/or the camera 42 may also be connected to the bus 52.

The reception device 38 may include a touch panel 38A, a microphone 38B, and/or the like, and may receive a user input. The touch panel 38A may detect a contact of a pointer (e.g., a pen, a finger, or the like) and may receive a user input based on the contact of the pointer. The microphone 38B may detect a user’s voice and may receive a user input based on the voice. A control unit 46A, which will be described later, may transmit data indicating the user input received through the touch panel 38A and/or the microphone 38B to the data processing device 12. In the data processing device 12, a specific processing unit 290, which will be described later, may acquire the data indicating the user input.

The output device 40 may include a display 40A, a speaker 40B, and/or the like, and may present data to the user by outputting the data in a user-perceptible expression (e.g., voice and/or text). The display 40A may display visible information such as text and images in accordance with an instruction from the processor 46. The speaker 40B may output a voice in accordance with an instruction from the processor 46. The camera 42 may include a small digital camera on which an optical system may be mounted. The optical system may includea lens, a diaphragm, a shutter, etc. and/or an imaging element, such as a complementary metal-oxide-semiconductor (CMOS) image sensor or a charge-coupled device (CCD) image sensor.

The communication I/F 44 may be connected to the network 54. The communication I/Fs 44 and 26 may manage the exchange of various types of information between the processor 46 and the processor 28 via the network 54.

In order to avoid complication, only one smart device 14 is illustrated in FIG. 1, but in various examples, a plurality of smart devices 14 may be installed in areas such as rooms and playgrounds where subjects (e.g., children) in a nursery school engage in activities and where the situations of the subjects engaged in the activities can be captured by the cameras 42.

The data processing system 10 according to the present example, may include a terminal 80 that may be connected to the network 54. Terminal 80 may be referred to as a guardian terminal 80 that is associated with or possessed by a guardian or other person who, for example, entrusts his/her child to the nursery school as a childcare recipient (hereinafter, simply referred to as “guardian”). In order to avoid complication, only one guardian terminal 80 is illustrated in FIG. 1, but in various examples, a plurality of terminals 80 may be connected to the network 54. For example, some or all guardians who entrust their children to the nursery school as childcare recipients may possess or use one of a plurality of different guardian terminals 80 connected to the network 54. Therefore, the data processing device 12 may be capable of exchanging various types of information with all of the guardian terminals 80.

Examples may include a mobile terminal, such as a smartphone or a tablet terminal, operating and/or being used as the guardian terminal 80, but the guardian terminal 80 is not limited to this mode. For example, a stationary terminal may operate and/or be used as the guardian terminal 80.

In addition, in the data processing system 10, a facility terminal 82 (also referred to as “childcare facility terminal 82”) may be provided in the nursery school and may be connected to the network 54, enabling the data processing device 12 to exchange various types of information with the childcare facility terminal 82.

Examples may include a stationary terminal operating and/or being used as the childcare facility terminal 82, but the childcare facility terminal is not limited to this mode. For example, a mobile terminal, such as a smartphone or a tablet terminal, may operate and/or be used as the childcare facility terminal 82.

Furthermore, in the data processing system 10 according to the present example, a terminal 84 (also referred to as “public institution terminal 84), for example, associated with or owned by an institution or other entity (e.g., public institution) that requires the nursery school to submit a predetermined report (hereinafter, simply referred to as “public institution”), may be connected to the network 54. Therefore, the data processing device 12 may also be capable of exchanging various types of information with the public institution terminal 84.

In the present example, a stationary terminal may operate and/or be used as the public institution terminal 84, but the public institution terminal 84 is not limited to this mode.

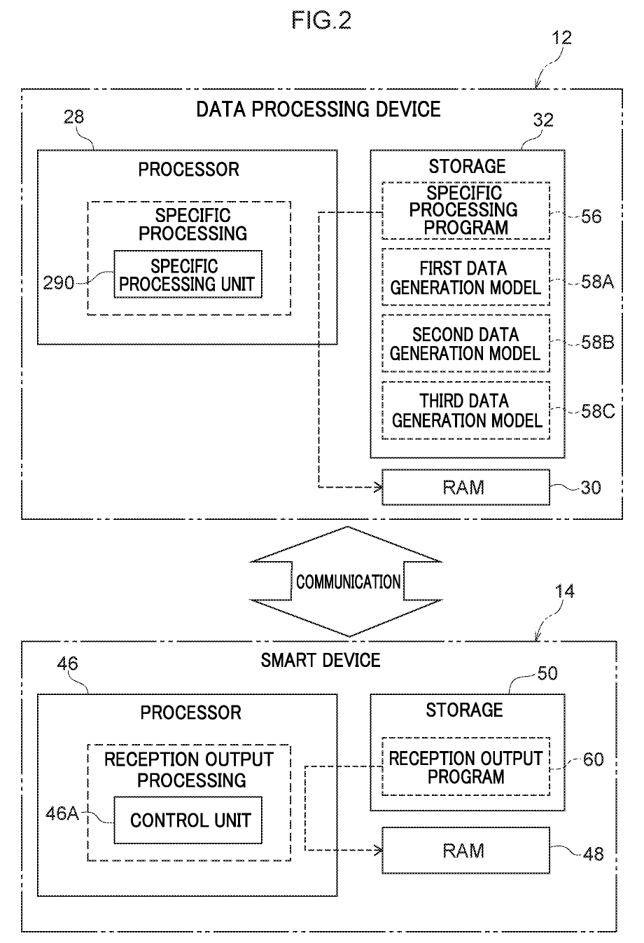

FIG. 2 illustrates examples of functions of parts of the data processing device 12 and the smart device 14.

As illustrated in FIG. 2, in the data processing device 12, specific processing may be performed by the processor 28. The storage 32 may store a specific processing program 56. The specific processing program 56 may be an example of a “data processing program” according to the technology of the present disclosure. The processor 28 may read the specific processing program 56 from the storage 32 and may execute the read specific processing program 56, for example, on the RAM 30. The specific processing may be realized by the processor 28 operating as the specific processing unit 290 according to the specific processing program 56 executed on the RAM 30.

The storage 32 may store data generation models, including: a first data generation model 58A, a second data generation model 58B, and/or a third data generation model 58C. The first data generation model 58A, the second data generation model 58B, and/or the third data generation model 58C may be used by the specific processing unit 290. The first data generation model 58A, the second data generation model 58B, and the third data generation model 58C will be collectively referred to herein as “data generation model 58” when described without distinction.

In the smart device 14, reception output processing may be performed by the processor 46. The storage 50 may store a reception output program 60. The reception output program 60 may be used in combination with the specific processing program 56 by the data processing system 10. The processor 46 may read the reception output program 60 from the storage 50 and may execute the read reception output program 60 on the RAM 48. The reception output processing may be realized by the processor 46 operating as the control unit 46A according to the reception output program 60 executed on the RAM 48.

Next, processing by the specific processing unit 290 when the data processing device 12 performs the specific processing to reduce the burden on the childcare provider in the childcare facility will be described.

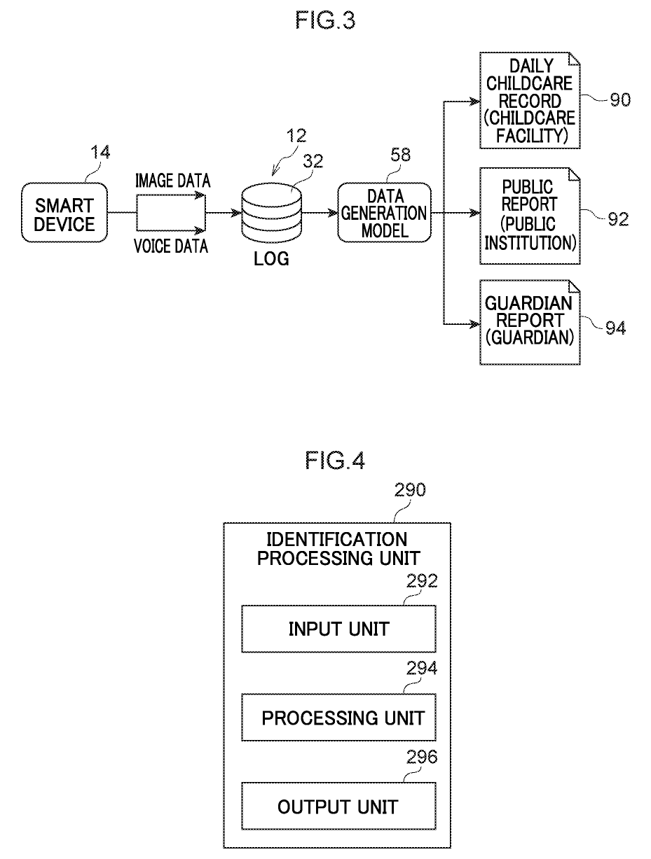

FIG. 3 is a diagram illustrating specific processing according to the present example. As illustrated in FIG. 3, the data processing system 10 in the present example may accumulate, in the storage 32 of the data processing device 12, image data indicating moving images captured by the camera 42 of the smart device 14 and voice data indicating time-series voices obtained by the microphone 38B of the smart device 14 as log data.

At this time, the data processing device 12 may detect each subject (e.g., child) from the image data using a predetermined object detection technology (for example, you only look once (YOLO)), and smay register an identifier (for example, a name) corresponding to the detected subject in the storage 32 in association with an image area for the detected subject.

Then, the specific processing in the present example may include first specific processing of generating childcare record information (e.g., daily childcare record information) indicating a childcare record 90 using the image data and the voice data accumulated in the storage 32 as the log data. The first specific processing may include receiving a correction to the childcare record indicated by the generated childcare record information.

In addition, the specific processing in the present example may include second specific processing of generating public report information indicating a public report 92 that, for example, may be submitted to the public institution using the image data and the voice data accumulated in the storage 32 as the log data. The second specific processing may include transmitting the generated public report information to the public institution.

Further, the specific processing in the present example may include third specific processing of generating guardian report information indicating a guardian report 94, that for example, may be reported to the guardian using the image data and the voice data accumulated in the storage 32 as the log data. The third specific processing may include transmitting the generated guardian report information to the guardian.

The data processing device 12 according to the present example may use the first data generation model 58A when performing the first specific processing. In addition, the data processing device 12 according to the present example may use the second data generation model 58B when performing the second specific processing. Furthermore, the data processing device 12 according to the present example may use the third data generation model 58C when performing the third specific processing.

In examples, the first specific processing, the second specific processing, and the third specific processing may be performed using the individually prepared data generation models 58 as described above, but the performing of the first specific processing, the second specific processing, and/or the third specific processing is not limited to this mode. For example, the first specific processing, the second specific processing, and/or the third specific processing may be performed using a single data generation model 58. Additionally and/or alternatively, a combination of two of the first specific processing, the second specific processing, and the third specific processing may be performed using a common data generation model 58, and the remaining specific processing may be performed using another data generation model 58.

As illustrated in FIG. 4, the specific processing unit 290 may include an input unit 292, a processing unit 294, and an output unit 296.

The input unit 292 may acquire user data. Specifically, the input unit 292 may acquire, as the user data, image data indicating an image of a childcare recipient (such as a child) in the childcare facility (such as a nursery school) and voice data indicating a voice around the childcare recipient. More specifically, the input unit 292 may acquire the image data and the voice data related to a plurality of childcare recipients (such as a plurality of children), which have been obtained by the smart device 14.

As described above, in examples, both the image data and the voice data may be acquired by the input unit 292, but the data acquisition is not limited to this mode. For example, only one of the image data and the voice data may be acquired by the input unit 292.

The processing unit 294 may perform specific processing using the data generation model 58, which generates a predetermined inference result (e.g., a result with inferred information of predetermined types or classes) according to the user data. For example, by inputting, to the data generation model 58, a prompt for instructing the data generation model 58 to generate report information for reporting the childcare status of the childcare recipient in the childcare facility based on the user data, the processing unit 294 may perform processing of generating the report information as the specific processing. More specifically, by inputting, into the data generation model 58, a prompt for instructing the data generation model 58 to generate report information for reporting the childcare status of the plurality of childcare recipients, the processing unit 294 may perform processing of generating the report information related to the plurality of childcare recipients as the specific processing.

The output unit 296 may output a result of the specific processing to a predetermined device. For example, the output unit 296 may output information based on the generated report information to a predetermined report destination device. The output unit 296 may output the information based on the generated report information to at least one of the guardian terminal 80, the childcare facility terminal 82, and/or the public institution terminal 84.

In the present example, as the report information, at least one of daily childcare record information indicating a daily childcare record, guardian report information indicating a report to a guardian of a childcare recipient, and public report information indicating a report to a public report destination may be applied.

By inputting, into the first data generation model 58A, a prompt for instructing the first data generation model 58A to generate daily childcare record information, the processing unit 294 may perform processing of generating the daily childcare record information as the first specific processing described above. Alternatively and/or in addition, by inputting, into the second data generation model 58B, a prompt for instructing the second data generation model 58B to generate public report information, the processing unit 294 may perform processing of generating the public report information as the second specific processing described above. Further, alternatively and/or in addition, by inputting, into the third data generation model 58C, a prompt for instructing the third data generation model 58C to generate guardian report information, the processing unit 294 may perform processing of generating the guardian report information as the third specific processing described above.

In a case where the report information includes guardian report information, the output unit 296 may output information based on the guardian report information to the guardian terminal 80 using, for example, a social networking service. In texamples, LINE (a registered trademark of LY Corporation of Tokyo, Japan) may be applied as the social networking service, but the social networking service is not limited to this mode. For example, another service such as + message (a Japanese registered trademark of NTT DOCOMO, INC., KDDI CORPORATION, and Softbank Corp.) or WHATSAPP (a registered trademark of WHATSAPP LLC of Menlo Park, California) may be applied as the social networking service.

The processing unit 294 may perform processing of estimating an emotion of the childcare recipient from the user data and generating report information by further using information indicating the estimated emotion as at least one of the first specific processing, the second specific processing, and the third specific processing.

The processing unit 294 may further perform, as the third specific processing, processing of detecting an event that occurred in the childcare facility based on the user data, and contacting the guardian of the childcare recipient, for example, based on detecting the event.

The first data generation model 58A, the second data generation model 58B, and/or the third data generation model 58C may include a generative artificial intelligence (AI) model. Examples of these data generation models 58 include generative AI such as ChatGPT (a registered trademark of OpenAI, Inc. of San Francisco, CA) (Internet search <URL:https://openai.com/blog/chatgpt>), Gemini (a registered trademark of Microsoft Corp. of Redmond, WA) (Internet search <URL:https://gemini.google.com/?hl=ja>) ), and/or a generative AI tool that can be instructed in a natural language based on large language models (LLMs) can be used. The data generation model 58 may be obtained by causing a neural network to perform deep learning. In some examples, the neural network is trained with example video and/or audio of a childcare recipient receiving childcare (for example, in a childcare facility), along with example reports (such as childcare records, public reports, and/or guardian reports associated with the video and/or audio). To the data generation model 58, a prompt including an instruction may be input, and inference data such as voice data indicating a voice, text data indicating a text, or image data indicating an image may be input. The data generation model 58 may infer the input inference data according to the instruction indicated by the prompt, and may output an inference result in a data format such as voice data, image data, or text data. Here, the inference may refer to, for example, analysis, classification, prediction, and/or summary.

For example, together with the latest image data and voice data for a past predetermined period (e.g., one day) acquired by the input unit 292, the processing unit 294 may input, into the first data generation model 58A, a prompt for generating daily childcare record information. For example, the prompt may include all or any portion of the following: “This is the latest image data and voice data indicating moving images for the past one day. While estimating an emotion of each child from these data, please generate information indicating a daily childcare record, including predetermined information for each child as daily childcare record information. The predetermined information may include a date, weather, a class, childcare status described in one line, a condition for each child, ...” (hereinafter, referred to as “first prompt”). Note that “...” in the first prompt indicates information indicating the childcare status that needs to be included in the daily childcare record information. As a result, the daily childcare record information described above may be generated by the first data generation model 58A.

Alternatively and/or addition, for example, together with the latest image data and voice data acquired by the input unit 292 for a predetermined period (e.g., the past six months), which may be a period for performing reporting through the public report 92, the processing unit 294 inputs, into the second data generation model 58B, a prompt to generate public report information. The prompt, for example, may include all or any portion of the following: “This is the latest image data and voice data indicating moving images for the past six months. While estimating an emotion of each child from these data, please generate information indicating a public report including predetermined information for each child as public report information. The predetermined information is ...” (hereinafter, referred to as “second prompt”). Note that “...” in the second prompt indicates information indicating the childcare status that needs to be included in the public report information. As a result, the public report information described above may be generated by the second data generation model 58B.

Alternatively and/or in addition, for example, together with the latest image data and voice data acquired by the input unit 292 for a predetermined period (e.g., the past one day), which may be a period for performing reporting with respect to the guardian, the processing unit 294 inputs, into the third data generation model 58C, a prompt for generating guardian report information. The prompt, for example, may include all or any portion of the following:“This is the latest image data and voice data indicating moving images for the past one day. While estimating an emotion of each child from these data, please generate information indicating a report to the guardian including predetermined information for each child as guardian report information. The predetermined information is ... Furthermore, when it is estimated that a certain event has been performed, please generate event information including information indicating the type of the event and an image in which the target child appears.” (hereinafter, referred to as “third prompt”). Note that “...” in the third prompt indicates information indicating the childcare status that needs to be included in the guardian report information. As a result, the guardian report information described above may be generated by the third data generation model 58C, and/or the above-described event information may be generated when a certain event occurred or is performed.

Next, the operation of the data processing system 10 will be described.

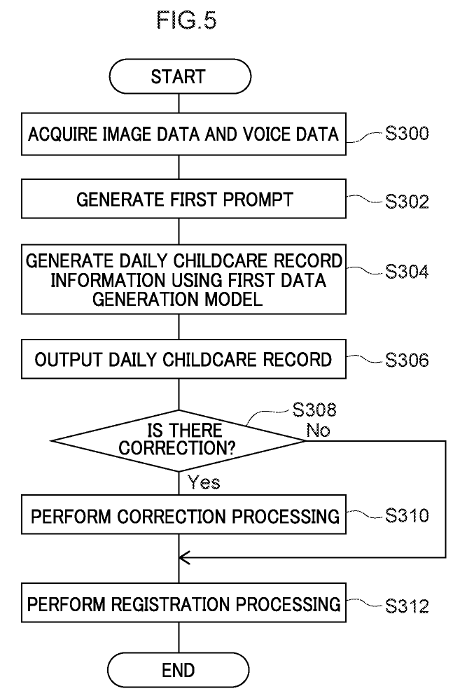

First, a flow of the first specific processing in the specific processing will be described with reference to FIG. 5. Note that the flow of the first specific processing illustrated in FIG. 5 is an example of a “data processing method” according to the technology of the present disclosure. The first specific processing according to the present example may be executed, for example, when the childcare hours at the nursery school end, and the execution may be instructed by a person, such as nursery school employee (e.g., teacher) who creates a daily childcare record for a current day via the childcare facility terminal 82 (hereinafter, simply referred to as “nursery school teacher”). Note that, in order to avoid complication here, a case where log data acquired from the smart device 14 may be accumulated for a predetermined period (for example, one day) or more will be described.

In step S300, the input unit 292 may read and/or acquire the latest image data and/or voice data for a period, such as the past one day, from the log data in the storage 32.

In step S302, the processing unit 294 may generate the first prompt as described above as an example.

In step S304, the processing unit 294 may generate the above-described daily childcare record information by inputting the generated first prompt together with the read image data and/or voice data into the first data generation model 58A.

In step S306, using the generated daily childcare record information, the output unit 296 may output (e.g., transmit), to the childcare facility terminal 82, the daily childcare record indicated by the daily childcare record information. The daily childcare record information may be in a predetermined format in such a manner as to display a daily record check screen for checking the daily childcare record. As a result, the daily record check screen may be displayed on a display unit of the childcare facility terminal 82. Any or all of the steps S300 to S312 may be performed autonomously by the processing unit 294, using, for example, cameras and microphones to capture data, generational models to generate prompts and record information, and memory and communication interfaces to store and transmit the record information.

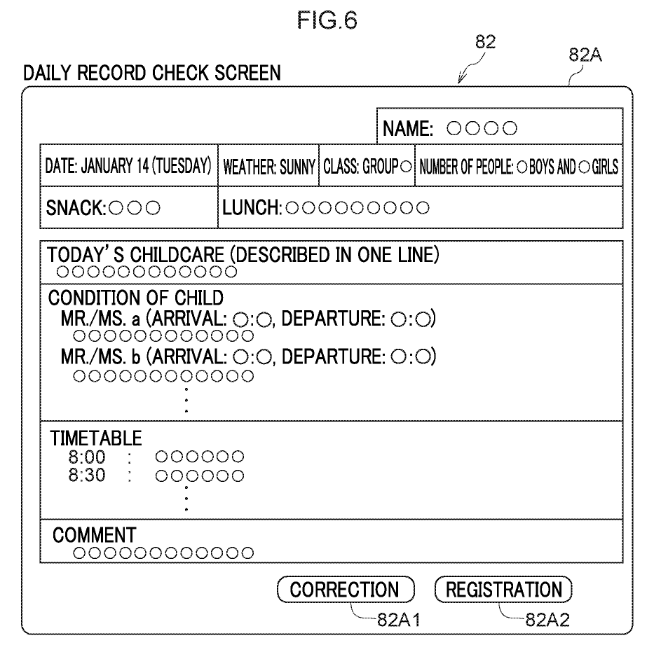

FIG. 6 illustrates an example of a daily record check screen that may be displayed on a display unit 82A of the childcare facility terminal 82 according to the present example.

As illustrated in FIG. 6, on the daily record check screen, information (e.g., predetermined types of information), such as the date, the weather, the class, the childcare status (e.g., described in one line), the condition for each child, the timetable, and/or the like included in the daily childcare record information generated by the first data generation model 58A may be displayed in a predetermined format. Note that the “weather” or the like included in the daily childcare record information does not need to be estimated from the read image data. For example, the weather may be included in the daily childcare record information by obtaining information indicating the weather of the current day from an external server or the like connected to the network 54 to provide weather information.

When the daily record check screen illustrated in FIG. 6 is displayed on the display unit 82A of the childcare facility terminal 82, a user such as the nursery school teacher may check the information displayed on the daily record check screen, select a correction button 82A1 when there is content to correct, and/or select a registration button 82A2 when there is no content to correct.

Therefore, in step S308, the processing unit 294 may determine whether or not the correction button 82A1 is selected by a user such as the nursery school teacher. Then, when a negative determination is made in this determination, it may be assumed that the registration button 82A2 may be selected by the user, and the processing may proceed to step S312. When a positive determination may be made, the processing may proceed to step S310.

In step S310, the processing unit 294 may execute correction processing of receiving a correction by the user (e.g., nursery school teacher) to the information displayed on the daily record check screen, and then may proceed to step S312.

In step S312, the output unit 296 may register the information displayed on the daily record check screen in the storage 32 as information indicating a final daily childcare record, and then may end the first specific processing.

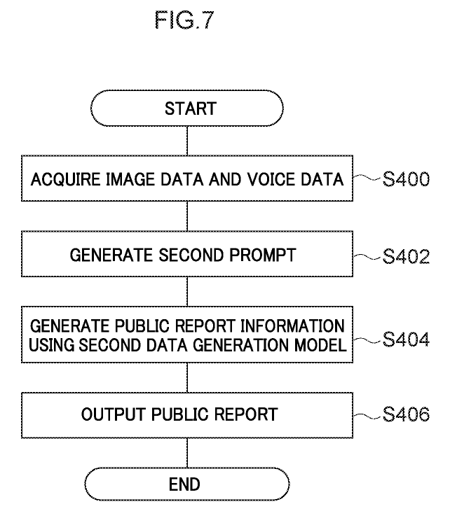

Next, a flow of the second specific processing in the specific processing will be described with reference to FIG. 7. Note that the flow of the second specific processing illustrated in FIG. 7 is also an example of a “data processing method” according to the technology of the present disclosure. The second specific processing according to the present example may be executed when the timing for transmitting public report information to a public institution is reached (for example, once every six months). Note that, in order to avoid complication here, a case where log data acquired from the smart device 14 may be accumulated for a predetermined period (for example, six months) or more will also be described.

In step S400, the input unit 292 may read and/or acquire the latest image data and/or voice data for a period, such as the past six months, from the log data in the storage 32.

In step S402, the processing unit 294 may generate the second prompt as described above as an example.

In step S404, the processing unit 294 may generate the above-described public report information by inputting the generated second prompt together with the read image data and/or voice data into the second data generation model 58B.

In step S406, the output unit 296 may output the generated public report information by transmitting it to the public institution, for example, after converting it into a predetermined format. The second specific processing may then end. Any or all of the steps S400 to S406 may be performed autonomously by the processing unit 294, using, for example, cameras and microphones to capture data, generational models to generate prompts and report information, and memory and communication interfaces to store and transmit the report information.

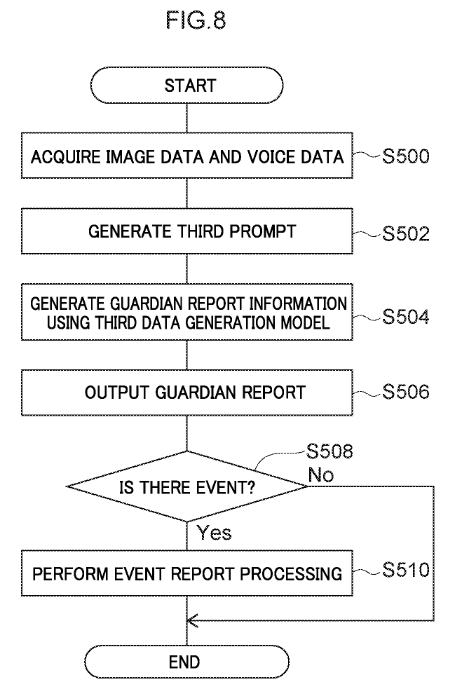

Next, a flow of the third specific processing in the specific processing will be described with reference to FIG. 8. Note that the flow of the third specific processing illustrated in FIG. 8 is also an example of a “data processing method” according to the technology of the present disclosure. The third specific processing according to the present example may be executed at a predetermined timing (for example, a timing at which the childcare hours at the nursery school end). Note that, in order to avoid complication here, a case where log data acquired from the smart device 14 may be accumulated for a predetermined period (for example, one day) or more will also be described.

In step S500, the input unit 292 may read and/or acquire the latest image data and/or voice data for a period, such as the past one day from the log data in the storage 32.

In step S502, the processing unit 294 may generate the third prompt as described above as an example.

In step S504, the processing unit 294 may generate the above-described guardian report information by inputting the generated third prompt together with the read image data and/or voice data into the third data generation model 58C.

In step S506, the output unit 296 may output the generated guardian report information by transmitting it to the guardian terminal 80, for example, after converting it into a predetermined format (for example, a format of LINE (a registered trademark of LY Corporation of Tokyo, Japan)).

In step S508, the processing unit 294 may determine whether or not the above-described event information has been generated by the third data generation model 58C. Then, when a negative determination is made in this determination, the third specific processing may end, and when a positive determination is made, the processing may proceed to step S510.

In step S510, the output unit 296 may execute event report processing of creating information in a predetermined format (for example, a format of LINE (a registered trademark of LY Corporation of Tokyo, Japan)) using the type of the event and the image in which the target person (e.g., child) appears, which may be indicated by the generated event information, (hereinafter, referred to as “event notification information”). The output unit 296 may transmit the created information to the guardian terminal 80 of each guardian. The third specific processing may then end. When the event notification information is received, an event report screen may be displayed on the display unit of the guardian terminal 80. Any or all of the steps S500 to S510 may be performed autonomously by the processing unit 294, using, for example, cameras and microphones to capture data, generational models to generate prompts, detect events and report information, and memory and communication interfaces to store and transmit the report and event information.

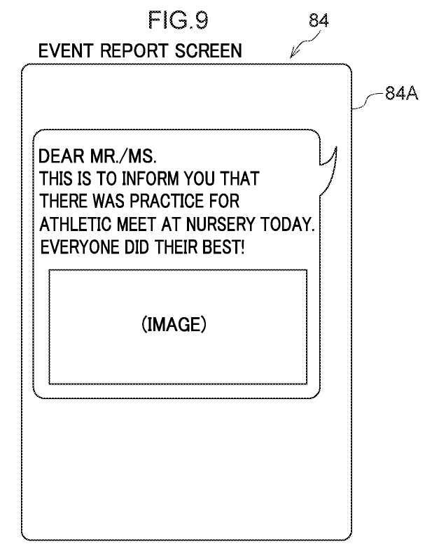

FIG. 9 illustrates an example of an event report screen that may be displayed on a display unit 84A of the guardian terminal 80 according to the present example.

As illustrated in FIG. 9, on this event report screen, information (e.g., predetermined types of information) indicating that there was a practice for an athletic meet on the current day may be displayed together with an image in which the person (e.g., child) appears. Accordingly, for example, the guardian can grasp that there was a practice for an athletic meet on the current day, together with its condition.

As described above, in the data processing system 10 according to the present example, the input unit 292 may acquire, as user data, image data indicating an image of a childcare recipient in a childcare facility, the processing unit 294 may perform, as specific processing, processing of generating report information for reporting childcare status of the childcare recipient in the childcare facility based on the user data by inputting, into a data generation model, a prompt for instructing the data generation model to generate the report information. The output unit 296 may output information based on the generated report information to a predetermined report destination device. Therefore, it may not be necessary to manually create report information from scratch, and as a result, it may be possible to reduce the burden on the childcare provider in the childcare facility.

In addition, the data processing system 10 according to the present example may further acquire voice data indicating a voice around the childcare recipient as the user data. Therefore, the voice data can be used alternatively and/or in addition to the image data for generating report information, and as a result, the report information can be generated more accurately as compared with that in a case where the voice data is not used.

In addition, in the data processing system 10 according to the present example, at least one of daily childcare record information, guardian report information, and public report information may be applied as the report information. Therefore, the burden on the childcare provider for creating the report information can be reduced.

In addition, in the data processing system 10 according to the present example, in a case where the report information may include guardian report information, information based on the guardian report information may be output to a device used by a guardian using a social networking service. Therefore, the guardian can grasp the content of the guardian report information using the social networking service with which the guardian is familiar, and as a result, it is possible to further improve the convenience for the guardian.

In addition, in the data processing system 10 according to the present example, the daily childcare record information (e.g., predetermined types of information) may include at least oneof a date, weather, a meal, a childcare outline (for example, corresponding to “childcare status described in one line” in the first prompt), a condition of the childcare recipient, and a timetable for a current day. Therefore, this information can be grasped from the daily childcare record information.

In addition, in the data processing system 10 according to the present example, processing of estimating an emotion of the childcare recipient from the user data and generating the report information by further using information indicating the estimated emotion may be performed as the specific processing. Therefore, the report information can be generated more accurately as compared with report information generated without using the emotion of the childcare recipient.

Furthermore, in the data processing system 10 according to the present example, processing of detecting an event that occurred or was performed in the childcare facility based on the user data, and optionally contacting a guardian of the childcare recipient (e.g., transmitting a message to a guardian device), may be further performed as the specific processing. Therefore, it is possible to further improve the convenience for the guardian.

Although the system according to the present disclosure has been described above mainly in terms of the functions of the data processing device 12, the system according to the present disclosure is not necessarily implemented on a server. The system according to the present disclosure may be implemented as a general information processing system, such as on a computing device comprising one or more processors and memory storing instructions that, when executed by the one or more processors, perform one or more steps (such as any of the steps described above). The present disclosure may additionally and/or alternatively be implemented as, for example, a software program operating on a personal computer or an application operating on a smartphone or the like. The method according to the present disclosure may additionally and/or alternatively be provided to a user in a software as a service (SaaS) format.

In the above-described example, the specific processing may be performed by one computer 22, but the technology of the present disclosure is not limited thereto, and the specific processing may be performed by a plurality of computers including the computer 22 in a distributed manner. For example, the data generation model 58 may be provided in a device external to the data processing device 12, and the external device may generate data according to input data.

In the above-described example, the specific processing program 56 may be stored in the storage 32, but the technology of the present disclosure need not be limited thereto. For example, the specific processing program 56 may be stored in a portable computer-readable non-transitory storage medium, such as a universal serial bus (USB) memory. The specific processing program 56 stored in the non-transitory storage medium may be installed in the computer 22 of the data processing device 12. The processor 28 may execute specific processing according to the specific processing program 56.

In addition, the specific processing program 56 may be stored in a storage device such as a server connected to the data processing device 12 via the network 54, and the specific processing program 56 may be downloaded and installed in the computer 22 (such as in response to a request from the data processing device 12).

Additionally and/or alternatively, it might not be necessary to store all of the specific processing program 56 in a storage device such as a server connected to the data processing device 12 via the network 54 or to store all of the specific processing program 56 in the storage 32, and a part of the specific processing program 56 may be stored.

The data processing program 56 may be provided as a program product. The program product may include any type of product for providing a program. Examples of the program product may include a program provided through a network such as the Internet and a non-transitory computer-readable recording medium such as a CD-ROM or a DVD storing the program.

The following various processors can be used as hardware resources that execute the specific processing. Examples of the processors include a CPU, which is a general-purpose processor functioning as a hardware resource that executes the specific processing by executing software, that is, a program. In addition, examples of the processors include a dedicated electric circuit, which is a processor having a circuit configuration exclusively designed for executing the specific processing, such as a field-programmable gate array (FPGA), a programmable logic device (PLD), or an application-specific integrated circuit (ASIC). A memory may be built in or connected to any processor, and any processor may execute specific processing, for example, by using the memory.

The hardware resource that executes the specific processing may be configured by one of these various processors, and/or may be configured by a combination of two or more processors of the same type or different types (e.g., a combination of a plurality of FPGAs or a combination of a CPU and an FPGA). The hardware resource that executes the specific processing may be one processor.

As an example in which the hardware resource that executes the specific processing is configured by one processor, first, there may be a mode in which one processor is configured by a combination of one or more CPUs and software, and this processor may function as a hardware resource that executes specific processing. Second, as represented by a system-on-a-chip (SoC) or the like, there may be a mode in which a processor that realizes the functions of the entire system, including a plurality of hardware resources that execute the specific processing on one IC chip may be used. In this manner, the specific processing may be realized by using one or more of the above-described various processors as hardware resources.

Furthermore, more specifically, an electric circuit in which circuit elements such as semiconductor elements are combined can be used as a hardware structure for these various processors. In addition, the above-described specific processing is merely an example.

Therefore, unnecessary steps may be deleted, new steps may be added, or the processing order may be changed without departing from the scope of the examples.

The above-described and illustrated contents are detailed descriptions of parts according to the technology of the present disclosure, and are merely examples of the technology of the present disclosure. For example, the above descriptions regarding configurations, functions, operations, and effects are descriptions regarding examples of configurations, functions, operations, and effects of parts according to the technology of the present disclosure. Therefore, unnecessary parts may be deleted, new parts may be added, or some parts may be replaced with respect to the above-described and illustrated contents without departing from the scope of the technology of the present disclosure. Furthermore, in order to avoid complication and to facilitate understanding of parts according to the technology of the present disclosure, in the above-described and illustrated contents, descriptions regarding common technical knowledge and the like that do not require any particular description to enable the implementation of the technology of the present disclosure are omitted.

All the documents, patent applications, and technical standards described in the present specification are incorporated herein by reference to the same extent as if each document, patent application, and technical standard were specifically and individually indicated to be incorporated by reference.

In the above-described examples, the data processing device of the present disclosure is applied to the data processing device 12 configured as a server, but the application of the data processing device of the present disclosure is not limited to this mode. For example, the data processing device of the present disclosure may be applied to the smart device 14 and/or the childcare facility terminal 82.

In addition, in the above-described examples where the daily record check screen is displayed on the childcare facility terminal 82, the display of the daily record check screen is not limited to this mode. For example, the daily record check screen may be displayed on the mobile terminal, for example, possessed by the nursery school teacher.

In addition, each of the first to third prompts described above is an example, and is not limited to the exemplified one.

In addition, the timing for executing each of the first specific processing, the second specific processing, and the third specific processing described above is an example, and is not limited to the exemplified one.

Furthermore, in the above-described examples where the smart device 14 is applied as a device for acquiring image data and voice data, the acquisition of image data and voice data is not limited to this mode. For example, additionally and/or alternatively to the smart device 14 acquiring image data and voice data, a robot including a camera and/or a microphone may be applied as a device for acquiring image data and voice data of the present disclosure.

With regard to the above-described examples, the following supplementary notes are further disclosed.

Supplementary Note 1 A data processing device including: an input unit configured to acquire user data; a processing unit configured to perform specific processing using a data generation model that generates a predetermined inference result according to the user data; and an output unit configured to output a result of the specific processing to a predetermined device, in which the input unit acquires, as the user data, image data indicating an image of a childcare recipient in a childcare facility, the processing unit performs, as the specific processing, processing of generating report information for reporting childcare status of the childcare recipient in the childcare facility based on the user data by inputting, into the data generation model, a prompt for instructing the data generation model to generate the report information, and the output unit outputs information based on the generated report information to a predetermined report destination device.

Supplementary Note 2 The data processing device according to supplementary note 1, in which the input unit further acquires, as the user data, voice data indicating a voice around the childcare recipient.

Supplementary Note 3 The data processing device according to supplementary note 1 or 2, in which the report information is at least one of daily childcare record information indicating a daily childcare record, guardian report information indicating a report to a guardian of the childcare recipient, and public report information indicating a report to a public report destination.

Supplementary Note 4 The data processing device according to supplementary note 3, in which in a case where the report information is guardian report information, the output unit outputs information based on the guardian report information to a device used by the guardian using a social networking service.

Supplementary Note 5 The data processing device according to supplementary note 3 or 4, in which the daily childcare record information includes at least one of a date, weather, a meal, a childcare outline, a condition of the childcare recipient, and a timetable for a current day.

Supplementary Note 6 The data processing device according to any one of supplementary notes 1 to 5, in which the processing unit performs, as the specific processing, processing of estimating an emotion of the childcare recipient from the user data and generating the report information by further using information indicating the estimated emotion.

Supplementary Note 7 The data processing device according to any one of supplementary notes 1 to 6, in which the processing unit further performs, as the specific processing, processing of detecting an event performed in the childcare facility based on the user data and contacting a guardian of the childcare recipient.

Supplementary Note 8 A data processing method executed by a computer, the data processing method including: acquiring user data; performing specific processing using a data generation model that generates a predetermined inference result according to the user data; and outputting a result of the specific processing to a predetermined device, in which image data indicating an image of a childcare recipient in a childcare facility is acquired as the user data, processing of generating report information for reporting childcare status of the childcare recipient in the childcare facility based on the user data by inputting, into the data generation model, a prompt for instructing the data generation model to generate the report information is performed as the specific processing, and information based on the generated report information is output to a predetermined report destination device.

Supplementary Note 9 A data processing program for causing a computer to execute: acquiring user data; performing specific processing using a data generation model that generates a predetermined inference result according to the user data; and outputting a result of the specific processing to a predetermined device, in which image data indicating an image of a childcare recipient in a childcare facility is acquired as the user data, processing of generating report information for reporting childcare status of the childcare recipient in the childcare facility based on the user data by inputting, into the data generation model, a prompt for instructing the data generation model to generate the report information is performed as the specific processing, and information based on the generated report information is output to a predetermined report destination device.

Supplementary Note 10 A data processing device comprising: one or more processors, a communication interface, and memory storing instructions that, when executed by the one or more processors, cause the data processing device to: acquire, as user data, image data indicating an image of a subject in a facility; provide the user data to a data generation model trained to determine a childcare status of a childcare recipient in a childcare facility; input a prompt to the data generation model, wherein the prompt instructs the data generation model to generate report information indicating the childcare status of the subject in the facility in the image; analyze, with the data generation model and based on the prompt, the user data to produce a predetermined inference result indicating the childcare status of the subject in the facility; generate the report information based on the predetermined inference result; and output, via the communication interface, the report information to a predetermined report destination device.

Supplementary Note 11 The data processing device according to Supplementary Note 10, wherein the instructions, when executed by the one or more the processors, cause the data processing device to acquire, as the user data, voice data indicating a voice in a vicinity of the subject.

Supplementary Note 12 The data processing device according to Supplementary Notes 10 or 11, wherein the report information includes at least one of: daily childcare record information indicating a daily childcare record, guardian report information indicating a guardian record, and public report information indicating a public record.

Supplementary Note 13 The data processing device according to Supplementary Note 12, wherein the report information includes the guardian report information, and the instructions, when executed by the one or more processors, cause the data processing device to output the report information to the predetermined report destination device using a social networking service.

Supplementary Note 14 The data processing device according to Supplementary Note 12, wherein the report information includes the daily childcare record information, which includes at least one of: a date, weather, a meal, a childcare outline, a condition of the subject, and a timetable for a current day.

Supplementary Note 15 The data processing device according to any of Supplementary Notes 10-14, wherein the instructions, when executed by the one or more the processors, cause the data processing device to: estimate an emotion of the subject from the user data; and generate the report information by further using the estimated emotion.

Supplementary Note 16 The data processing device according to any of Supplementary Notes 10-15, wherein the instructions, when executed by the one or more the processors, cause the data processing device to: detect an event that occurred in the facility based on the user data; and transmitting, via a network, event notification information to a remote device.

Supplementary Note 17 The data processing device according to any of Supplementary Notes 10-16, wherein the data generation model comprises a large language generative AI model.

Supplementary Note 18 A method comprising: acquiring, as user data from a camera, image data indicating an image of a subject in a facility; providing, with a data processing device, the user data to a data generation model trained to determine a childcare status of a childcare recipient in a childcare facility; inputting, with the data processing device, a prompt to the data generation model, wherein the prompt instructs the data generation model to generate report information indicating the childcare status of the subject in the facility in the image; analyzing, with the data generation model and based on the prompt, the user data to produce a predetermined inference result indicating the childcare status of the subject in the facility; generating, with the data processing device, the report information based on the predetermined inference result; and outputting, via a communication interface, the report information to a predetermined report destination device.

Supplementary Note 19 The method according to Supplementary Note 18, further comprising: acquiring, as the user data, voice data indicating a voice in a vicinity of the subject.

Supplementary Note 20 The method according to Supplementary Notes 18 or 19, wherein the report information includes at least one of: daily childcare record information indicating a daily childcare record, guardian report information indicating a guardian record, and public report information indicating a public record.

Supplementary Note 21 The method according to Supplementary Note 20, wherein the report information includes the guardian report information, and wherein the outputting of the report information to the predetermined report destination device uses a social networking service.

Supplementary Note 22 The method according to Supplementary Note 20, wherein the report information includes the daily childcare record information, which includes at least one of: a date, weather, a meal, a childcare outline, a condition of the subject, and a timetable for a current day.

Supplementary Note 23 The method according to any of Supplementary Notes 18-22, further comprising: estimating, with the data processing device, an emotion of the subject from the user data; and generating the report information by further using the estimated emotion.

Supplementary Note 24 The method according to any of Supplementary Notes 18-23, further comprising: detecting, with the data processing device, an event that occurred in the facility based on the user data; and transmitting, using the communication interface via a network, event notification information to a remote device.

Supplementary Note 25 The method according to any of Supplementary Notes 18-24, wherein the data generation model comprises a large language generative AI model.

Supplementary Note 26 One or more non-transitory computer-readable media storing instructions that, when executed by one or more processors of a data processing device, cause the data processing device to: acquire, as user data, image data indicating an image of a subject in a facility; provide the user data to a data generation model trained to determine a childcare status of a childcare recipient in a childcare facility; input a prompt to the data generation model, wherein the prompt instructs the data generation model to generate report information indicating the childcare status of the subject in the facility in the image; analyze, with the data generation model and based on the prompt, the user data to produce a predetermined inference result indicating the childcare status of the subject in the facility; generate the report information based on the predetermined inference result; and output the report information to a predetermined report destination device.

Supplementary Note 27 The one or more non-transitory computer-readable media of Supplementary Note 26, wherein the instructions, when executed by the one or more processors, further cause the data processing device to acquire, as the user data, voice data indicating a voice in a vicinity of the subject.

Supplementary Note 28 The one or more non-transitory computer-readable media of Supplementary Notes 26 or 27, wherein the report information includes at least one of: daily childcare record information indicating a daily childcare record, guardian report information indicating a guardian record, and public report information indicating a public record.

Supplementary Note 29 The one or more non-transitory computer-readable media of Supplementary Note 28, wherein the report information includes the guardian report information, and wherein the instructions, when executed by the one or more processors, further cause the data processing device to output the report information to the predetermined report destination device using a social networking service.

Any of the above devices and/or methods may be implemented in different forms. For example, a method may be implemented via a data processing device comprising one or more processors and memory storing instructions that, when executed by the one or more processors, cause performance of one or more steps of the method. As another example, steps performed by a computing device may instead be described as a method. Any such steps may additionally and/or alternatively be performed by one or more non-transitory computer-readable media and/or a system comprising one or more different devices.

What is claimed is:

1. A data processing device comprising:
one or more processors,
a communication interface, and
memory storing instructions that, when executed by the one or more processors, cause the data processing device to:
acquire, as user data, image data indicating an image of a subject in a facility;
provide the user data to a data generation model trained to determine a childcare status of a childcare recipient in a childcare facility;
input a prompt to the data generation model, wherein the prompt instructs the data generation model to generate report information indicating the childcare status of the subject in the facility in the image;
analyze, with the data generation model and based on the prompt, the user data to produce a predetermined inference result indicating the childcare status of the subject in the facility;
generate the report information based on the predetermined inference result; and
output, via the communication interface, the report information to a predetermined report destination device.

2. The data processing device according to claim 1, wherein the instructions, when executed by the one or more the processors, cause the data processing device to acquire, as the user data, voice data indicating a voice in a vicinity of the subject.

3. The data processing device according to claim 1, wherein the report information includes at least one of: daily childcare record information indicating a daily childcare record, guardian report information indicating a guardian record, and public report information indicating a public record.

4. The data processing device according to claim 3, wherein the report information includes the guardian report information, and the instructions, when executed by the one or more processors, cause the data processing device to output the report information to the predetermined report destination device using a social networking service.

5. The data processing device according to claim 3, wherein the report information includes the daily childcare record information, which includes at least one of: a date, weather, a meal, a childcare outline, a condition of the subject, and a timetable for a current day.

6. The data processing device according to claim 1, wherein the instructions, when executed by the one or more the processors, cause the data processing device to:
estimate an emotion of the subject from the user data; and
generate the report information by further using the estimated emotion.

7. The data processing device according to claim 1, wherein the instructions, when executed by the one or more the processors, cause the data processing device to:
detect an event that occurred in the facility based on the user data; and
transmit, via a network, event notification information to a remote device.

8. The data processing device according to claim 1, wherein the data generation model comprises a large language generative AI model.

9. A method comprising:
acquiring, as user data from a camera, image data indicating an image of a subject in a facility;
providing, with a data processing device, the user data to a data generation model trained to determine a childcare status of a childcare recipient in a childcare facility;
inputting, with the data processing device, a prompt to the data generation model, wherein the prompt instructs the data generation model to generate report information indicating the childcare status of the subject in the facility in the image;
analyzing, with the data generation model and based on the prompt, the user data to produce a predetermined inference result indicating the childcare status of the subject in the facility;
generating, with the data processing device, the report information based on the predetermined inference result; and
outputting, via a communication interface, the report information to a predetermined report destination device.

10. The method according to claim 9, further comprising:
acquiring, as the user data, voice data indicating a voice in a vicinity of the subject.

11. The method according to claim 9, wherein the report information includes at least one of: daily childcare record information indicating a daily childcare record, guardian report information indicating a guardian record, and public report information indicating a public record.

12. The method according to claim 11, wherein the report information includes the guardian report information, and wherein the outputting of the report information to the predetermined report destination device uses a social networking service.

13. The method according to claim 11, wherein the report information includes the daily childcare record information, which includes at least one of: a date, weather, a meal, a childcare outline, a condition of the subject, and a timetable for a current day.

14. The method according to claim 9, further comprising:
estimating, with the data processing device, an emotion of the subject from the user data; and
generating the report information by further using the estimated emotion.

15. The method according to claim 9, further comprising:
detecting, with the data processing device, an event that occurred in the facility based on the user data; and
transmitting, using the communication interface, event notification information to a remote device via a network.

16. The method according to claim 9, wherein the data generation model comprises a large language generative AI model.

17. One or more non-transitory computer-readable media storing instructions that, when executed by one or more processors of a data processing device, cause the data processing device to:
acquire, as user data, image data indicating an image of a subject in a facility;
provide the user data to a data generation model trained to determine a childcare status of a childcare recipient in a childcare facility;
input a prompt to the data generation model, wherein the prompt instructs the data generation model to generate report information indicating the childcare status of the subject in the facility in the image;
analyze, with the data generation model and based on the prompt, the user data to produce a predetermined inference result indicating the childcare status of the subject in the facility;
generate the report information based on the predetermined inference result; and
output the report information to a predetermined report destination device.

18. The one or more non-transitory computer-readable media of claim 17, wherein the instructions, when executed by the one or more processors, further cause the data processing device to acquire, as the user data, voice data indicating a voice in a vicinity of the subject.

19. The one or more non-transitory computer-readable media of claim 17, wherein the report information includes at least one of: daily childcare record information indicating a daily childcare record, guardian report information indicating a guardian record, and public report information indicating a public record.

20. The one or more non-transitory computer-readable media of claim 19, wherein the report information includes the guardian report information, and wherein the instructions, when executed by the one or more processors, further cause the data processing device to output the report information to the predetermined report destination device using a social networking service.
